(19) United States
(12) Patent Application Publication
(10) Pub. No.: US 2022/0250701 A1
(43) Pub. Date: Aug. 11, 2022

(54) STORAGE COMPARTMENT FOR AN ELECTRIC MOTORCYCLE AND ELECTRIC MOTORCYCLE HAVING THE SAME

(71) Applicant: Zapp Electric Vehicles Limited, London (GB)

(72) Inventors: Swin Chatsuwan, London (GB); Warin Thanathawee, London (GB); Namkarn Munprasit, London (GB)

(73) Assignee: Zapp Electric Vehicles Limited, London (GB)

(21) Appl. No.: 17/732,606

(22) Filed: Apr. 29, 2022

Related U.S. Application Data
(63) Continuation of application No. PCT/IB2019/059344, filed on Oct. 31, 2019.

(51) Int. Cl. B62J 9/14; B62J 1/08

(52) U.S. Cl. CPC B62J 9/14; B62J 1/08

(57) ABSTRACT

A seat support portion of an electric motorcycle includes: a frame that supports a seat; and a tray having a flat structure. The frame has a folded structure having opposing sides. The frame and the tray are attached to each other and define a storage compartment of the electric motor cycle. The folded structure of the frame partially defines the storage compartment.

### TECHNICAL FIELD

The present invention relates to motorcycles and scooters, in particular those driven by electric power.

### BACKGROUND

Design of storage compartments is essential to the vehicle's utility. Competing concerns of the storage compartment's capacity, the entire vehicle's weight or weight distribution, and space optimization (among others) must be carefully balanced. This is truer when the vehicle in question is a motorcycle, a scooter or such, which has less capacity, weight and space—the resources to be optimized—to begin with. Specifically, it is even more challenging to design a storage compartment for electrically-driven motorcycles or scooters, owing to their relatively low driving power and hence an additional constraint of needing to be made much lighter than their fuel-driven counterparts.

It has always been accepted that adding or increasing the capacity of storage compartment entails a compromise of mobility. And such “mobility” is inclusive of the vehicle's speed, as well as balance and ability to travel in a narrow path. At one extreme, some existing models choose to forego the storage completely.

Examples of such existing model include a disclosure per the People's Republic of China's Patent Publication No. CN 102039959. There, a storage case configuration construction of electric motorcycle is installed beneath the seat cushion of the electric motorcycle. The inside of the storage case comprises a front storage space with an opening formed on the bottom and a rear storage space behind the opened front storage space. Moreover, a pedestal is disposed correspondingly under the opened front storage space; a tail case is installed on the rear part of the rear storage space; the tail case includes a tail case room, and is in communication with the rear storage space. Such storage case is not only bulky, but it is also semi-permanent; it offers the user little room to adjust to accommodate situational needs.

### SUMMARY

One or more embodiments of the present invention provide a storage compartment for motorcycles and scooters, especially those driven by electric power, while minimizing the effects of foregoing trade-off.

One or more embodiments of the present invention address the dichotomy between capacity and mobility, so as to provide a more versatile vehicle.

Embodiments in accordance with the present invention provide a novel storage compartment for an electric motorcycle, or an electric motorcycle having such storage compartment. An underlying concept is to design the essential member of vehicle's structure, most likely a frame that supports the vehicle's seating, to have a folded structure. Such folded structure may open at a predetermined angle so as to form generally opposing sides of the frame. These opposing sides partially define the storage compartment of the electric motorcycle, and are further utilized by way of attaching another member, said another member being a tray in particular embodiments, to that frame so as to additionally define said storage compartment. With this latter member being attached, the enclosure is just sufficient to form a storage compartment.

Optionally, the latter member may be configured to be detachable from the structure, or yet additional enclosure may be provided. This way, the degree of enclosure, the storage capacity, and even the inclusion of storage compartment itself, may be customized by the user at great flexibility. In particular, the storage compartment may be completely removed to maximize mobility; a less enclosed storage compartment provides a sufficient holding of stored article while allowing part of the stored article to extend beyond the compartment's edges, and thus is useful when the shape of stored article cannot fit into a more enclosed storage compartment; a more enclosed compartment may be used when the stored article is small.

For avoidance of doubt, the terms “fold”, and “folded structure”, or like, are inclusive of a structure that is bent or curved so long that it effectively provides a partial enclosure to a space that may be utilized by the concept of the present invention. In the same vein, the terms “fold line”, and “vertex”, or like, are irrespective of its conspicuousness or sharpness so long that it effectively indicates the region where the relevant sides adjoin. It follows that a “folded structure”, or like, in this application, may project a resemblance of an acute angle, a parabolic curve, an arc, or a U-shape, among others, so long as such structure falls within the concept of the present invention.

In one or more embodiments, a storage compartment for an electric motorcycle, comprises (i) a first rigid member having a fold line at which a first side and a second side of the storage compartment adjoin; and (ii) a second rigid member, characterized in that (A) the first rigid member is fixedly attached to the electric motorcycle; and (B) the second rigid member is capable of being attached to the electric motorcycle, providing at least one additional side of the storage compartment.

Such storage compartment's second rigid member may be capable of detachably attached to the electric motorcycle.

Such storage compartment may further comprise a reinforcement member that is capable of being attached to the electric motorcycle, providing mechanical support to the second rigid member while being attached to the electric motorcycle.

Such storage compartment may further comprise a third member for providing an additional enclosure to the storage compartment.

The third member may be made of a flexible material or a rigid material. An example of the third member being made of a flexible material is one or more embodiments wherein the third member is a net.

The third member may provide the additional enclosure in place of the first side and the second side.

In one or more embodiments, a seat support portion of an electric motorcycle, comprises: (i) a frame to support a seat; and a tray having a flat structure, characterized in that said frame has a folded structure that forms generally opposing sides of the frame that partially define a storage compartment of the electric motorcycle, and that the frame and the tray are attached so as to additionally define said storage compartment. The folded structure of such seat support portion may be curved.

Such seat support portion's tray and the frame may be capable of being detachably assembled.

Such seat support portion's folded structure may have a vertex pointing towards the front of the electric motorcycle.

The storage compartment may be formed under the seat.

In one or more embodiments, an electric motorcycle comprises any of the abovementioned seat support portions.

For a better understanding of the concept of present invention, one or more embodiments will now be described in details, by way of non-limiting examples only, with reference to the accompanying drawings.

### BRIEF DESCRIPTION OF THE DRAWINGS

FIG. 1 shows an electric motorcycle's folded member before the formation of storage compartment in accordance with one or more embodiments (not to scale).

FIG. 2 shows an electric motorcycle's folded member during the assembly of storage compartment having partial enclosure in accordance with one or more embodiments (not to scale).

FIG. 3 shows a storage compartment for an electric motorcycle having partial enclosure in accordance with one or more embodiments (not to scale).

FIG. 4 shows an electric motorcycle's folded member during the assembly of storage compartment having full enclosure in accordance with one or more embodiments (not to scale).

FIG. 5 shows a storage compartment for an electric motorcycle having full enclosure in accordance with one or more embodiments (not to scale).

FIG. 6 shows an electric motorcycle having a storage compartment in accordance with one or more embodiments (not to scale).

FIG. 7 shows a storage compartment for an electric motorcycle enclosed with a net in accordance with one or more embodiments (not to scale).

### DETAILED DESCRIPTION

Unless indicated otherwise, certain terminologies are used in the following description for general illustration purpose only and shall not be construed to limit the scope of the concept of the present invention in any way. Likewise, any specific configurations, figures and dimensions herein are for illustrating purpose and should not be construed to limit the scope of the concept of this technical disclosure.

Unless indicated otherwise, the terminology “electric motorcycle” shall be inclusive of any vehicle running on two wheels that are significantly driven by electric power, irrespective of circumstantial features or specifications, such as power outputs, types of motor, or electric cell. Examples of “electric motorcycle” under this meaning shall include so-called electric scooters and hybrid motorcycles, among others, which may be appreciated by a person having ordinary skills in the relevant technical field.

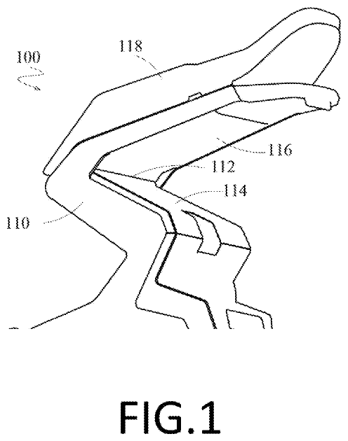

FIG. 1 shows one or more embodiments of an electric motorcycle's folded member. In one or more embodiments, an electric motorcycle's 10 (not shown in FIG. 1) first rigid member is a folded member which forms a seat support portion 100. The seat support portion 100 comprises a frame 110. Here, the frame 110 has a folded structure, and hence a fold line 112 at which a first side 114 and a second side 116 adjoin. In one or more embodiments, the frame 110 is folded at a predetermined angle so as to form an open fold having the first side 114 and the second side 116 generally opposed to each other. Such first side 114 and second side 116 are intended for forming the sides, i.e. internal walls, of a storage compartment which will be described later. A seat 118 is provided such that it is mounted atop and supported by the frame 110.

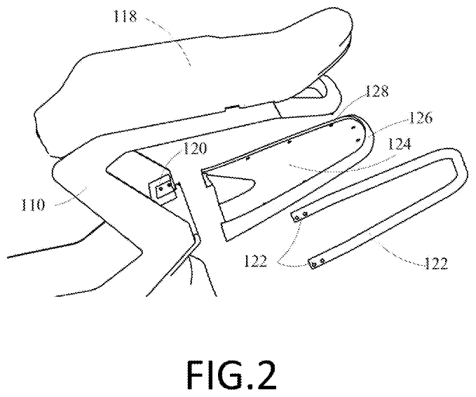

FIG. 2 shows one or more embodiments of an electric motorcycle's folded member during the assembly of storage compartment having partial enclosure. In one or more embodiments, the first side 114 (not shown on FIG. 2) is removable from the frame 110. Removing the first side 114 from the frame 110 reveals sockets 120 for insertion of a reinforcement member 122 (i.e., support), which in one or more embodiments is a u-shaped metal rod. The reinforcement member 122 provides mechanical support to a second rigid member, which in one or more embodiments is a tray 124. The tray 124 may have a flat structure, and a curved portion 126 configured to bend downwards so as to engage with the reinforcement member 122. In one or more embodiments, the assembly of storage compartment having partial enclosure begins with removing the first side 114 from the frame 110; inserting the legs 123 of reinforcement member 122 into the sockets 120 and attaching the reinforcement member 122 to the sockets 120 with screws (not shown); mounting the tray 124 atop the reinforcement member 122 with the curved portion 126 engaging the reinforcement member 122; attaching the tray 124 to the reinforcement member 122 with screws 128; and then reinstalling the first side 114 to the frame 110.

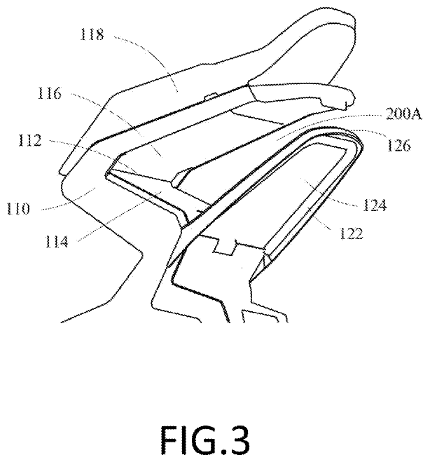

Completion of the foregoing steps forms a storage compartment having partial enclosure 200A under the seat 118, as shown in FIG. 3. In one or more embodiments, the first side 114 and the second side 116, which are permanent part of the frame 110 adjoining at the fold line 112, form the sides of the storage compartment having partial enclosure 200A. And the tray 124, now attached to the frame 110 and mechanically supported by the reinforcement member 122, provides an additional side to the storage compartment having partial enclosure 200A. Any user may build the storage compartment having partial enclosure 200A by performing these steps or undo the storage compartment having partial enclosure 200A by reversing such steps with ease in a matter of 1-3 minutes without help of a technician.

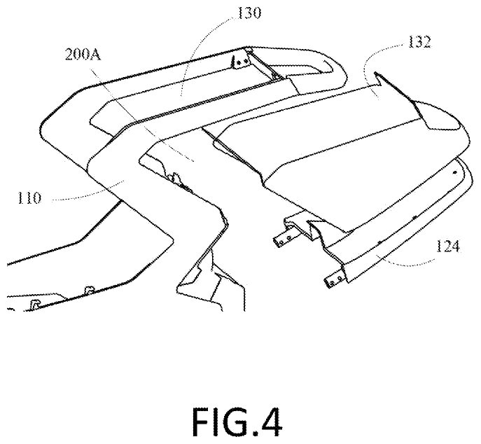

Further, FIG. 4 shows one or more embodiments of an electric motorcycle's folded member during the assembly of storage compartment having full enclosure. In one or more embodiments, the second side 116 (not shown on FIG. 4) is removable from the frame 110. Removing the second side 116 from the frame 110 reveals an upper opening 130 through which a third member for additionally defining the storage compartment, in one or more embodiments said third member being a cover 132, may be inserted. The cover 132 in one or more embodiments is made of rigid material. In one or more embodiments, the assembly of storage compartment having full enclosure begins with assembling the storage compartment having partial enclosure 200A per the previous description in connection with FIG. 2, without the final step of reinstalling the first side 114 (not shown on FIG. 4) to the frame 110; removing the second side 116 and the seat 118 (not shown in FIG. 4) from the frame 110; inserting the cover 132 through the upper opening 130 such that the cover 132 is mounted atop and supported by the tray 124 and the shape of cover 132 fits with the adjoining components, providing a full enclosure to the storage compartment. In one or more embodiments, predetermined sides of the cover 132 when assembled as per the foregoing steps also provide the enclosure in place of the first side 114 and the second side 116 of the frame 110, respectively, and so reinstalling the first side 114 and the second side 116 to the frame 110 is unnecessary.

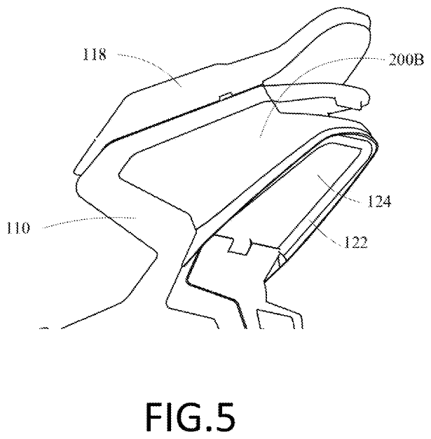

Completion of the foregoing steps forms a storage compartment having full enclosure 200B under the seat 118, as shown in FIG. 5. Any user may build the storage compartment having full enclosure 200B by performing these steps or undo the storage compartment having full enclosure 200B by reversing such steps with ease in a matter of 1-3 minutes without help of a technician.

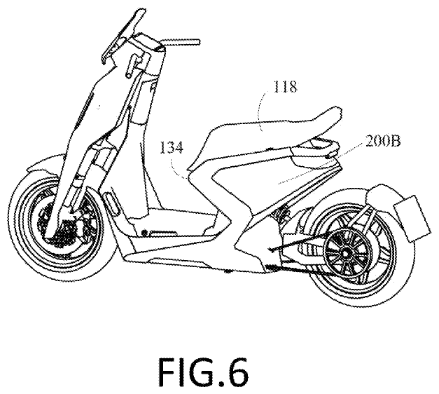

FIG. 6 shows an electric motorcycle 10 in accordance with one or more embodiments, wherein the storage compartment having full enclosure 200B has already been assembled under the seat 118. In one or more embodiments, the vertex 134 of the frame 110 having a folded structure points toward the front of the electric motorcycle 10, providing an angle for the seat 118 that is comfortable to the user.

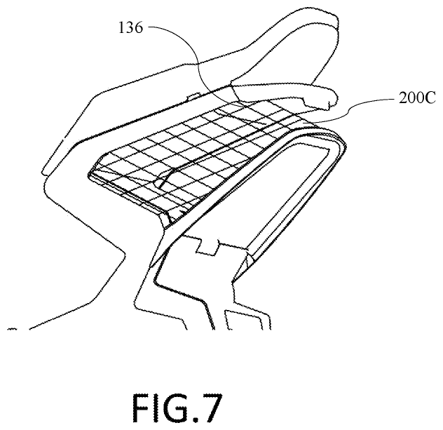

FIG. 7 shows a storage compartment for an electric motorcycle enclosed with a net in accordance with one or more embodiments. In one or more embodiments, the third member for additionally defining the storage compartment is a made of a flexible material, in particular a net 136. According to one or more embodiments, the assembly of storage compartment begins with assembling the storage compartment having partial disclosure 200A (not shown in FIG. 7) per the previous description in connection with FIG. 2; removing the second side 116 and the seat 118 from the frame 110 per the previous description in connection with FIG. 4; inserting the net 136 through the upper opening 130 such that net 136 provides an additional enclosure; and then reinstalling the second side 116 and the seat 118. Completion of the foregoing steps forms a storage compartment enclosed by a net 200C under the seat 118. In one or more embodiments, there are a plurality of hooks (not shown in FIG. 7) coupled to the first side 114, second side 116, and tray 124, upon which the net 136 is hung, providing aid to the attachment of the net 136 to the frame 110.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A seat support portion of an electric motorcycle, the seat support portion comprising:
a frame that supports a seat; and
a tray having a flat structure, wherein
the frame has a folded structure having opposing sides,
the frame and the tray are attached to each other and define a storage compartment of the electric motorcycle, and
the folded structure of the frame partially defines the storage compartment.

2. The seat support portion according to claim 1, wherein the folded structure is curved.

3. The seat support portion according to claim 1, wherein the frame and the tray are capable of being detached.

4. The seat support portion according to claim 1, wherein the folded structure comprises a vertex pointing towards a front of the electric motorcycle.

5. The seat support portion according to claim 1, wherein the storage compartment is formed under the seat.

6. The seat support portion according to claim 1, wherein the frame is detachably attached to a support that supports the tray.

7. The seat support portion according to claim 1, wherein the frame is detachably attached to a rigid cover that additionally defines the storage compartment.

8. The seat support portion according to claim 1, wherein the frame is detachably attached to a net that additionally defines the storage compartment.

9. An electric motorcycle comprising the seat support portion according to claim 1.
